(19) United States
(12) Patent Application Publication
(10) Pub. No.: US 2024/0277010 A1
(43) Pub. Date: Aug. 22, 2024

(54) BEVERAGE

(71) Applicant: MORINAGA & CO., LTD., Tokyo (JP)

(72) Inventors: Ayaka OKUBO, Kanagawa (JP); Masaaki NISHIMURA, Kanagawa (JP); Yusuke NOGUCHI, Kanagawa (JP)

(73) Assignee: MORINAGA & CO., LTD., Tokyo (JP)

(21) Appl. No.: 18/567,410

(22) PCT Filed: Jun. 3, 2022
(86) PCT No.: PCT/JP2022/022596

§ 371 Date: Dec. 6, 2023

(30) Foreign Application Priority Data
Jun. 7, 2021 (JP) 2021-095252

(51) Int. Cl. A23L 2/60; A23L 2/66

(52) U.S. Cl. CPC A23L 2/60; A23L 2/66

(57) ABSTRACT

An object of the present invention is to provide a highly palatable collagen-rich beverage. An object of a preferred embodiment of the present invention is to provide a beverage having both an improved collagen-specific taste and a balanced sweetness. The present invention to solve the above problems is a beverage containing 5 mass % or more of collagen, which contains 0.0003 mass % to 0.15 mass % of a stevia extract and 0.1 mass % to 16 mass % of sugar (sucrose) in a content mass ratio of from 1:40000 to 1:0.6.

### TECHNICAL FIELD

The present invention relates to a collagen-rich beverage.

### BACKGROUND ART

In recent years, collagen-containing beverages have been widely distributed.

Patent Literature 1 discloses a food and beverage containing a composition having a collagen odor at a high concentration. As described in Patent Literature 1, addition of a stevia extract is known as a method for controlling a collagen odor.

Here, as described in Patent Literature 2, the stevia extract is known to have a problem of having a strange taste in addition to a sweetness and a sweetness remaining in the mouth for a long time (residual aftertaste). In addition, Patent Literature 2 discloses an agent for improving the taste quality of the stevia extract, which includes somatin as an active ingredient.

### CITATION LIST

### Patent Literature

Patent Literature 1: JP 2008-037758 A
Patent Literature 2: JP 2011-024445 A

### SUMMARY OF INVENTION

### Technical Problem

While various palatable beverages have been proposed, further development of novel collagen beverages has been required.

Here, natural sweeteners are less sweet and thicker than artificial sweeteners, and sugar alone is too sweet and lacks balance.

In addition, in the development of new palatable beverages, the collagen-specific taste has been a problem when the collagen content is high. In addition, when the collagen content is high, there was a problem in improving the collagen-specific taste and balancing sweetness of the beverage.

An object of the present invention made in view of the above circumstances is to provide a beverage having both an improved collagen-specific taste and a balanced sweetness.

Further, an object of the present invention made in view of the above circumstances is to provide a highly palatable beverage.

As a result of intensive studies, the inventors found that in the production of a collagen-rich beverage, the combination of a stevia extract, collagen, and sugar is important to balance the flavor of the beverage.

### Solution to Problem

That is, the present invention to solve the above problems is a beverage containing 5 mass % or more of collagen, which contains 0.0003 mass % to 0.15 mass % of a stevia extract and 0.1 mass % to 16 mass % of sugar (sucrose) in a content mass ratio of from 1:40,000 to 1:0.6.

A beverage containing 5 mass % or more of collagen, which contains 0.0003 mass % to 0.15 mass % of a stevia extract and 0.1 mass % to 16 mass % of sugar (sucrose) in a content mass ratio of from 1:40,000 to 1:0.6, can more reliably reduce the collagen-specific taste, even if its collagen content is high.

In addition, when a beverage contains 5 mass % or more of collagen, and contains 0.0003 mass % to 0.15 mass % of a stevia extract and 0.1 mass % to 16 mass % of sugar (sucrose) in a content mass ratio of from 1:40,000 to 1:0.6, the provided beverage has both an improved collagen-specific taste and a balanced sweetness, even if its collagen content is high.

In addition, the above form can provide a highly palatable beverage.

In a preferred embodiment of the invention, the stevia extract includes rebaudioside A and/or stevioside.

In a preferred embodiment of the present invention, the collagen content in the beverage is 40 mass % or less.

A preferred embodiment of the invention further contains a Rakanka extract.

In a preferred embodiment of the invention, the content mass ratio of the stevia extract to the Rakanka extract is from 1:0.05 to 1:0.2.

The present invention is also a beverage containing 5 mass % or more of collagen,
which contains 0.0003 mass % to 0.15 mass % of rebaudioside A and/or stevioside and 0.1 mass % to 16 mass % of sugar (sucrose) in a content mass ratio of from 1:40000 to 1:0.6.

The present invention is also
a method for producing a collagen-rich beverage having an improved taste, including a step of adjusting
5 mass % or more of collagen,
0.0003 mass % to 0.15 mass % of a stevia extract, and 0.1 mass % to 16 mass % of sugar (sucrose)
so that the content mass ratio of the stevia extract to sugar (sucrose) is from 1:40,000 to 1:0.6.

The present invention can provide a beverage having both an improved collagen-specific taste and a balanced sweetness, even if its collagen content is high.

The present invention can also provide a highly palatable beverage.

### Advantageous Effects of Invention

The present invention can provide a beverage having both an improved collagen-specific taste and a balanced sweetness, even if its collagen content is high. The present invention can also provide a highly palatable beverage.

### DESCRIPTION OF EMBODIMENTS

Hereinafter, embodiments of the present invention will be described and provided for understanding of the present invention. Note that the following embodiments are examples embodying the present invention, and can be appropriately modified within the scope described in the claims.

The beverage of the present invention is a beverage containing collagen, a stevia extract, and sugar (sucrose).

The collagen content in the beverage of the present invention is 5 mass % or more.

In addition, the stevia extract content in the beverage of the present invention is from 0.0003 mass % to 0.15 mass %.

The sugar (sucrose) content in the beverage of the present invention is from 0.1 mass % to 16 mass %.

The beverage of the present invention is characterized in that the content mass ratio of the stevia extract to sugar (sucrose) is from 1:40,000 to 1:0.6.

The above form can provide a beverage having both an improved collagen-specific taste and a balanced sweetness, even if its collagen content is high.

In addition, the above form can provide a highly palatable beverage.

Preferred forms of the ingredients contained in the beverage of the present invention will be described below.

In the description herein regarding the content (concentration) and physical properties of each ingredient, the “entire beverage” refers to the entire edible portion contained in the container and does not include the container unless otherwise specified.

### [Collagen]

The more preferred forms of collagen will be described below.

The ingredient mass ratio in the following description refers to the ingredient mass ratio of collagen in the produced beverage unless otherwise specified.

The origin of collagen contained in the beverage of the present invention is not particularly limited.

Examples of collagen used in the beverage of the present invention include collagen derived from fish, birds, cattle, and pigs.

When collagen is prepared from a natural product, the method for preparing collagen is not particularly limited, and a method for preparing collagen from a natural product by a prior art method can be adopted. The collagen may be a commercially available pharmaceutical or food raw material.

The collagen referred to in the present invention also includes collagen peptides obtained by degrading and reducing the molecular weight of collagen through enzymatic treatment.

Here, the average molecular weight of the collagen peptide contained in the beverage of the present invention is preferably 500 or more, more preferably 700 or more, and even more preferably 900 or more.

The average molecular weight of the collagen peptide contained in the beverage of the present invention is preferably 10,000 or less, more preferably 5,000 or less, and even more preferably 3,000 or less.

Here, the method for calculating the average molecular weight of collagen is not particularly limited as long as the method is capable of calculating the average molecular weight from the composition of the molecular weight of collagen in the product. and examples thereof include a method for calculating the average molecular weight by quantitative analysis using a high performance liquid chromatography apparatus and a method for calculating the average molecular weight by performing electrophoresis treatment after quantitative determination using an ELISA method.

The collagen content in the beverage is preferably 5 mass % or more, more preferably 6 mass % or more, and even more preferably 7.5 mass % or more.

In addition, the collagen content in the beverage is preferably 40 mass % or less, more preferably 30 mass % or less, even more preferably 20 mass % or less, and particularly preferably 10 mass % or less.

### [Sugar (Sucrose)]

The more preferred forms of sugar (sucrose) extract will be described below.

The ingredient mass ratio in the following description refers to the ingredient mass ratio of sugar (sucrose) in the produced beverage unless otherwise specified.

The sugar (sucrose) content in the beverage is preferably 0.1 mass % or more, more preferably 1 mass % or more, even more preferably 3 mass % or more, and particularly preferably 4.5 mass % or more.

The sugar (sucrose) content in the beverage is preferably 16 mass % or less, more preferably 13 mass % or less, and even more preferably 8 mass % or less.

The sugar (sucrose) may be a commercially available pharmaceutical or food raw material.

Here, the “content mass of sugar (sucrose)/content mass of collagen” in the beverage is preferably 3.3 or less, more preferably 3 or less, even more preferably 2 or less, yet even more preferably 1 or less, and particularly preferably 0.7 or less.

In addition, the “content mass of sugar (sucrose)/content mass of collagen” in the beverage is preferably 0.002 or more, more preferably 0.002 or more, even more preferably 0.15 or more, yet even more preferably 0.4 or more, and particularly preferably 0.5 or more.

When the ratio of the content mass of sugar (sucrose) to the content mass of collagen in a beverage is within the above range, the provided beverage has both an improved collagen-specific taste and a balanced sweetness, even if its collagen content is high.

In addition, the above form can provide a highly palatable beverage.

### [Stevia Extract]

The more preferred forms of the stevia extract will be described below.

The ingredient mass ratio in the following description refers to the ingredient mass ratio of the stevia extract in the produced beverage unless otherwise specified.

Stevia extract is an extract from Stevia (Stevia Rebaudiana).

The extract of stevia (Stevia Rebaudiana) used may be purchased from commercial extracts of stevia (Stevia Rebaudiana) sold by companies dealing in plant materials.

Alternatively, an extract of stevia (Stevia Rebaudiana) may be prepared by extracting wild or grown stevia (Stevia Rebaudiana). Here, the extract of stevia (Stevia Rebaudiana) is preferably prepared by extracting leaves of stevia (Stevia Rebaudiana).

In the extraction of stevia (Stevia Rebaudiana), stevia (Stevia Rebaudiana) leaves are preferably dried and pulverized or chopped beforehand to improve extraction efficiency.

The extract can be obtained, for example, by the following method. First, 1 to 30 parts by mass of a solvent is added to 1 part by mass of a leaf of Stevia (Stevia Rebaudiana) or a dried product thereof, and the mixture is immersed for several days at room temperature or several hours at a temperature near the boiling point of the solvent. After immersion, the mixture is cooled to room temperature, and insoluble matters are removed as desired, and then the solvent is removed by concentration under reduced pressure or other means. The desired extract can then be obtained by fractionation purification using column chromatography packed with silica gel or an ion exchange resin.

The extraction solvent is preferably a polar solvent, and suitable examples thereof include one or two or more selected from water, alcohols such as ethanol, isopropyl alcohol, and butanol, polyvalent alcohols such as 1,3-butylene glycol and polypropylene glycol, ketones such as acetone and methyl ethyl ketone, and ethers such as diethyl ether and tetrahydrofuran.

In the present invention, rebaudioside A and/or stevioside may also be used as an ingredient corresponding to the stevia extract.

In the present invention, the numerical range for the use of the stevia extract may be used as the preferred numerical range for the use of rebaudioside A and/or stevioside.

The stevia extract content in the beverage is preferably 0.0003 mass % or more, more preferably 0.0007 mass % or more, and even more preferably 0.001 mass % or more.

In addition, the stevia extract in the beverage is preferably 0.15 mass % or less, more preferably 0.1 mass % or less, and even more preferably 0.05 mass % or less.

The beverage in which the content mass of the stevia extract is within the above range can more reliably reduce the collagen-specific taste, even if its collagen content is high.

Here, the content mass ratio of the stevia extract to sugar (sucrose) in the beverage is preferably from 1:40000 to 1:0.6, more preferably from 1:10,000 to 1:5, and even more preferably from 1:5,000 to 1:15.

In addition, the “content mass of stevia extract/content mass of sugar (sucrose)” in the beverage is preferably 1.5 or less, more preferably 1.3 or less, even more preferably 0.5 or less, yet even more preferably 0.1 or less, and particularly preferably 0.005 or less.

In addition, the “content mass of stevia extract/content mass of sugar (sucrose)” in the beverage is preferably 0.00003 or more, more preferably 0.0005 or more, and even more preferably 0.001 or more.

When the ratio of the content mass of the stevia extract to the content mass of sugar (sucrose) in a beverage is within the above range, the provided beverage has both an improved collagen-specific taste and a balanced sweetness, even if its collagen content is high.

In addition, the above form can provide a highly palatable beverage.

In addition, the “content mass of stevia extract/content mass of collagen” in the beverage is preferably 0.022 or less, and more preferably 0.002 or less.

In addition, the “content mass of stevia extract/content mass of collagen” in the beverage is preferably 0.0000125 or more, and more preferably 0.0005 or more.

The beverage in which the ratio of the content mass of the stevia extract to the content mass of collagen is within the above range can more reliably reduce the collagen-specific taste, even if its collagen content is high.

### [Rakanka Extract]

The more preferred forms of the Rakanka extract will be described below.

The ingredient mass ratio in the following description refers to the ingredient mass ratio of the Rakanka extract in the produced beverage unless otherwise specified.

The Rakanka extract refers to an extract from Rakanka (Siraitia grosvenorii), which is a highly sweetened sweetener containing mogroside and others.

In addition, in the present invention, mogroside may also be used as an ingredient corresponding to the Rakanka extract.

In the present invention, the numerical range for the use of the Rakanka extract may be used as the preferred numerical range for the use of mogroside.

The extract of Rakanka (Siraitia grosvenorii) used may be purchased from commercial extracts of Rakanka (Siraitia grosvenorii) sold by companies dealing in plant materials.

Alternatively, an extract of Rakanka (Siraitia grosvenorii) may be prepared by extracting wild or grown Rakanka (Siraitia grosvenorii). Here, it is desirable to produce an extract of Rakanka (Siraitia grosvenorii) by extracting the fruit of Rakanka (Siraitia grosvenorii).

In the extraction of Rakanka (Siraitia grosvenorii), Rakanka (Siraitia grosvenorii) fruits are preferably dried and pulverized or chopped beforehand to improve extraction efficiency.

The extract can be obtained, for example, by the following method. First, 1 to 30 parts by mass of a solvent is added to 1 part by mass of a Rakanka (Siraitia grosvenorii) fruit or a dried product thereof, and the mixture is immersed for several days at room temperature or several hours at a temperature near the boiling point of the solvent. After immersion, the mixture is cooled to room temperature, and insoluble matters are removed as desired, and then the solvent is removed by concentration under reduced pressure or other means. The desired extract can then be obtained by fractionation purification using column chromatography packed with silica gel or an ion exchange resin.

The extraction solvent is preferably a polar solvent, and suitable examples thereof include one or two or more selected from water, alcohols such as ethanol, isopropyl alcohol, and butanol, polyvalent alcohols such as 1,3-butylene glycol and polypropylene glycol, ketones such as acetone and methyl ethyl ketone, and ethers such as diethyl ether and tetrahydrofuran.

The Rakanka extract content in the beverage is preferably 0.0003 mass % or more, more preferably 0.0007 mass % or more, and even more preferably 0.001 mass % or more.

In addition, the Rakanka extract content in the beverage is preferably 0.15 mass % or less, more preferably 0.1 mass % or less, and even more preferably 0.05 mass % or less.

Here, the content mass ratio of the Rakanka extract to sugar (sucrose) in the beverage is preferably from 1:400,000 to 1:6, more preferably from 1:10,0000 to 1:50, and even more preferably from 1:5,0000 to 1:150.

In addition, the “content mass of Rakanka extract/content mass of sugar (sucrose)” in the beverage is preferably 0.15 or less, more preferably 0.13 or less, even more preferably 0.05 or less, yet even more preferably 0.01 or less, and particularly preferably 0.0005 or less.

In addition, the “content mass of Rakanka extract/content mass of sugar (sucrose)” in the beverage is preferably 0.000003 or more, more preferably 0.00005 or more, and even more preferably 0.0001 or more.

The beverage in which the mass ratio of the content mass of the Rakanka extract to sugar (sucrose) is within the above range can reliably reduce the collagen-specific taste, even if its collagen content is high.

In addition, when the mass ratio of the content mass of the Rakanka extract to the sugar (sucrose) in a beverage is within the above range, the provided beverage has both an improved collagen-specific taste and a balanced sweetness, even if its collagen content is high.

In addition, the above form can provide a highly palatable beverage.

In addition, the “content mass of Rakanka extract/content mass of collagen extract” in the beverage is preferably 0.0002 or less, and more preferably 0.0001 or less.

In addition, the “content mass of Rakanka extract/content mass of collagen extract” in the beverage is preferably 0.00003 or more, and more preferably 0.00005 or more.

The beverage in which the mass ratio of the Rakanka extract to collagen is within the above range can more reliably reduce the collagen-specific taste, even if its collagen content is high.

In addition, when the mass ratio of the Rakanka extract to collagen in a beverage is within the above range, the provided beverage has both an improved collagen-specific taste and a balanced sweetness, even if its collagen content is high.

In addition, the above form can provide a highly palatable beverage.

Here, the content mass ratio of the stevia extract to the Rakanka extract in the beverage is preferably from 1:0.05 to 1:0.2, and more preferably from 1:0.07 to 1:0.15.

The beverage in which the content mass ratio of the stevia extract to the Rakanka extract is within the above range can more reliably reduce the collagen-specific taste, even if its collagen content is high.

In addition, when the content mass ratio of the stevia extract to the Rakanka extract in a beverage is within the above range, the provided beverage has both an improved collagen-specific taste and a balanced sweetness, even if its collagen content is high.

In addition, the above form can provide a highly palatable beverage.

### [Fruit Juice]

In the present invention, the beverage may contain fruit juice.

Fruits used as raw materials of fruit juice are not limited regardless whether they are concentrated or straight fruit juice as long as they are used in vegetable juice, beverages containing fruit juice, fruit juice, and the like.

In particular, in the present invention, it is preferable to use fruit juice made from peaches and/or lemons.

The fruit juice content in the beverage of the present invention is preferably 1 mass % or more, and more preferably 5 mass % or more in terms of straight juice.

The fruit juice content in the beverage of the present invention is preferably 50 mass % or less, and more preferably 40 mass % or less in terms of straight juice.

Here, it is known that addition of fruit juice to a collagen-containing beverage increases the taste.

In the present invention, even in a form containing fruit juice within the above range, it is possible to improve the collagen-specific taste and balance the sweetness of the beverage.

The beverage of the present invention may optionally contain other ingredients normally used in beverages, as long as the effect of the present invention is not impaired.

Examples of the optional ingredient include sweeteners, flavorings, colorings, pH adjusting agents, edible metal salts, excipients, amino acids, vitamins, minerals, antioxidants, preservatives, antibacterial agents, and bacteriostatic agents.

Preferred embodiments of the beverage of the present invention will be described below.

The Brix of the beverage is preferably 10 or more, more preferably 15 or more.

The Brix of the beverage is preferably 60 or less, more preferably 45 or less, and even more preferably 35 or less.

Examples of a method of calculating the Brix value of the beverage include a method of measuring the Brix value using a sugar content meter. Other examples of the method include a method of calculating the Brix value using a refractometer, and a method of determining the Brix value by comparing the sugar concentration in the beverage to a Brix value calibration curve.

The Brix value of the beverage can be adjusted by adjusting the soluble solids content in the beverage.

The pH of the beverage is preferably 2 or more, and more preferably 3 or more.

The pH of the beverage is preferably 6 or less, more preferably 5 or less, and even more preferably 4.5 or less.

The kind of the pH adjusting agent is not particularly limited as long as the effect of the present invention is achieved, but for example, it can be appropriately adjusted by using one or more known pH adjusting agents.

The viscosity of the beverage at 20° C. is preferably 2 cP or more, more preferably 3 cP or more, and even more preferably 5 cP or more.

The viscosity of the beverage at 20° C. is preferably 50 cP or less, and more preferably 30 cP or less.

The viscosity of the beverage at 20° C. may be a value measured using a B-type viscometer (manufactured by Tokyo Keiki Inc., 20° C., measurement time 60 seconds, rotor and number of rotations adjusted as appropriate according to viscosity of sample).

The container used for the beverage of the present invention is not particularly limited, and may be any paper container, plastic bottle, glass bottle, or can.

The capacity of the container is also not particularly limited.

The capacity of the container is preferably 30 mL or more, and more preferably 100 mL or more.

In addition, the capacity of the container is preferably 2000 mL or less, more preferably 1600 mL or less, and even more preferably 600 mL or less.

### <Method for Producing Beverage>

Hereinafter, a method for producing a beverage of the present invention will be described.

The method for producing a beverage of the present invention is
a method for producing a collagen-rich beverage having an improved taste, including a step of adjusting
5 mass % or more of collagen,
0.0003 mass % to 0.15 mass % of a stevia extract, and 0.1 mass % to 16 mass % of sugar (sucrose)
so that the content mass ratio of the stevia extract to sugar is from 1:40,000 to 1:0.6.

The production method of the present invention can efficiently produce a collagen-rich beverage having an improved taste.

In addition, the description of the beverage of the present invention described above directly applies to preferred embodiments (each ingredient and physical properties) in the method for producing a beverage of the present invention.

### EXAMPLES

Hereinafter, the present invention will be described in more detail by way of examples. Unless otherwise stated, pig-derived collagen having an average molecular weight of 2,000 was used. An 85 mass % solution of phosphoric acid and a 50 mass % solution of phytic acid were used as raw materials.

However, the present invention is not limited to the following examples, unless the gist of the present invention is exceeded.

### Test Example 1

### (1) Production of Beverage

Test beverages for examples and comparative examples were produced by mixing 5 mass % of fruit juice in terms of straight juice, 0.5 mass % of flavoring, ingredients shown in Table 1, and water.

### (2) Evaluation Test

The produced test beverages for examples and comparative examples were subjected to sensory evaluation by five evaluators (evaluators A to E in the table) who are experts in research and development of beverages.

The evaluator evaluated each test beverage according to the following criteria.

### (2-1) Evaluation Conditions Common to all Evaluations

First, the collagen concentration is disclosed to the evaluator for each test beverage.

The evaluator performs the evaluation according to the disclosed collagen concentration.

### (2-2) Evaluation Items

### <Sweetness Intensity>

For sweetness intensity, the left end was defined as 1 point (no sweetness) and the right end as 5 points (strong sweetness). The evaluator tasted 20 mL of each test beverage and evaluated the sweetness intensity after tasting, according to the above definition (average rating and evaluations by the evaluators A to E are shown in the table).

The minimum unit of the evaluation was 0.5.

Then, for the evaluation by the evaluator, scores (average scores in the table) were assigned to the following indexes.
1: −2 points (no sweetness/too strong sweetness; not well-balanced sweetness)
2: −1 points (excellent balance of sweetness)
3: 0 point (best balance of sweetness)
4: −1 points (excellent balance of sweetness)
5: −2 points (no sweetness/too strong sweetness; not well-balanced sweetness)

### <Cohesion of Flavor>

For the degree of balance between sweetness and bitterness, the left end was defined as 1 point (poor balance of sweetness and bitterness) and the right end as 5 points (excellent balance between sweetness and bitterness).

Then, the evaluators tasted 20 mL of each test beverage and evaluated the degree of balance between sweetness and bitterness after tasting, in light of the above definition (evaluations by the evaluators A to E are shown in the table).

The minimum unit of the evaluation was 0.5.

### <Degree of Reduction of Strange Taste (Masking)>

For the degree of reduction of strange taste (masking), the left end was defined as 1 point (no reduction of the unique flavor derived from the collagen raw material), and the right end as 5 points (reduction of the unique flavor derived from the collagen raw material).

Then, the evaluators tasted 20 mL of each test beverage and evaluated the reduction of strange taste (masking) after tasting, in light of the above definition (average evaluation and evaluations by the evaluators A to E are shown in the table).

The minimum unit of the evaluation was 0.5.

### <Overall Favorability of Beverage>

For the degree of palatability of the collagen beverage, the left end was defined as 1 point (poor palatability of the collagen beverage), and the right end as 5 points (excellent palatability of the collagen beverage).

Then, the evaluators tasted 20 mL of each test beverage and evaluated the degree of palatability of the collagen beverage after tasting, in light of the above definition (average evaluation and evaluations by the evaluators A to E are shown in the table).

The minimum unit of the evaluation was 0.5.

### <Total/Sensory Evaluation>

Each of the above four items was scored, and those having a higher total score were determined to be favorable in terms of quality, and were expressed by the following criteria.
Total score of 4 items is 10 or more: o
Total score of 4 items is less than 10: x
   <pH>

The pH of the produced beverage was measured using a PH meter.

### <Brix Value (Bx.)>

The Brix value of the beverage was measured by a method of determining the Brix value by comparing the concentration of the soluble solid content in the beverage to the Brix value calibration curve.

<Viscosity (cP)>

The viscosity of the beverage at 20° C. was measured using a B-type viscometer (manufactured by Tokyo Keiki Inc., 20° C., measurement time 60 seconds, rotor and number of rotations adjusted as appropriate according to viscosity of sample).

TABLE 1

| | Compar- | Compar- | | | | | | | | | | Compar- | Compar- |
|---|---|---|---|---|---|---|---|---|---|---|---|---|---|
| | ative | ative | Exam- | Exam- | Exam- | Exam- | Exam- | Exam- | Exam- | Exam- | Exam- | ative | ative |
| | Example 1 | Example 2 | ple 1 | ple 2 | ple 3 | ple 4 | ple 5 | ple 6 | ple 7 | ple 8 | ple 9 | Example 3 | Example 4 |
| Raw material | | | | | | | | | | | | | |
| ( [symbol] units of | | | | | | | | | | | | | |
| ingredients, | | | | | | | | | | | | | |
| mass %) | | | | | | | | | | | | | |
| Collagen | [symbol] | [symbol] | [symbol] | [symbol] | [symbol] | [symbol] | [symbol] | [symbol] | [symbol] | [symbol] | [symbol] | [symbol] | [symbol] |
| Sugar ( [symbol] ) | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] |
| Malic acid | [symbol] | [symbol] | [symbol] | [symbol] | [symbol] | [symbol] | [symbol] | | | | | | |
| [symbol] acid | | | | | | | | [symbol] | [symbol] | [symbol] | [symbol] | [symbol] | [symbol] |
| [symbol] acid | | | | | | | | [symbol] | [symbol] | [symbol] | [symbol] | [symbol] | [symbol] |
| Physical | | | | | | | | | | | | | |
| properties [symbol] | | | | | | | | | | | | | |
| pH | [symbol] | [symbol] | [symbol] | [symbol] | [symbol] | [symbol] | [symbol] | [symbol] | [symbol] | [symbol] | [symbol] | [symbol] | [symbol] |
| Brix value ( [symbol] ) | [symbol] | [symbol] | [symbol] | [symbol] | [symbol] | [symbol] | [symbol] | [symbol] | [symbol] | [symbol] | [symbol] | [symbol] | [symbol] |
| Viscosity ( [symbol] ) | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] | X | X | ◯ | ◯ | ◯ | ◯ | ◯ | ◯ | ◯ | ◯ | ◯ | [symbol] | X |
| | Compar- | Compar- | | | | | | | | | | Compar- | Compar- |
| | ative | ative | Exam- | Exam- | Exam- | Exam- | Exam- | Exam- | Exam- | Exam- | Exam- | ative | ative |
| [ [symbol] ] | Example 1 | Example 2 | ple 1 | ple 2 | ple 3 | ple 4 | ple 5 | ple 6 | ple 7 | ple 8 | ple 9 | Example 3 | Example 4 |
| Sweetness | | | | | | | | | | | | | |
| intensity | | | | | | | | | | | | | |
| Average [symbol] | [symbol] | [symbol] | [symbol] | [symbol] | [symbol] | [symbol] | [symbol] | [symbol] | [symbol] | [symbol] | [symbol] | [symbol] | [symbol] |
| Average score | [symbol] | [symbol] | [symbol] | [symbol] | [symbol] | [symbol] | [symbol] | [symbol] | [symbol] | [symbol] | [symbol] | [symbol] | [symbol] |
| [symbol] by [symbol] A | [symbol] | [symbol] | [symbol] | [symbol] | [symbol] | [symbol] | [symbol] | [symbol] | [symbol] | [symbol] | [symbol] | [symbol] | [symbol] |
| [symbol] by [symbol] B | [symbol] | [symbol] | [symbol] | [symbol] | [symbol] | [symbol] | [symbol] | [symbol] | [symbol] | [symbol] | [symbol] | [symbol] | [symbol] |
| [symbol] by [symbol] C | [symbol] | [symbol] | [symbol] | [symbol] | [symbol] | [symbol] | [symbol] | [symbol] | [symbol] | [symbol] | [symbol] | [symbol] | [symbol] |
| [symbol] by [symbol] D | [symbol] | [symbol] | [symbol] | [symbol] | [symbol] | [symbol] | [symbol] | [symbol] | [symbol] | [symbol] | [symbol] | [symbol] | [symbol] |
| [symbol] by [symbol] E | [symbol] | [symbol] | [symbol] | [symbol] | [symbol] | [symbol] | [symbol] | [symbol] | [symbol] | [symbol] | [symbol] | [symbol] | [symbol] |
| Cohesion | | | | | | | | | | | | | |
| of flavor | | | | | | | | | | | | | |
| Average [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] by [symbol] A | [symbol] | [symbol] | [symbol] | [symbol] | [symbol] | [symbol] | [symbol] | [symbol] | [symbol] | [symbol] | [symbol] | [symbol] | [symbol] |
| [symbol] by [symbol] B | [symbol] | [symbol] | [symbol] | [symbol] | [symbol] | [symbol] | [symbol] | [symbol] | [symbol] | [symbol] | [symbol] | [symbol] | [symbol] |
| [symbol] by [symbol] C | [symbol] | [symbol] | [symbol] | [symbol] | [symbol] | [symbol] | [symbol] | [symbol] | [symbol] | [symbol] | [symbol] | [symbol] | [symbol] |
| [symbol] by [symbol] D | [symbol] | [symbol] | [symbol] | [symbol] | [symbol] | [symbol] | [symbol] | [symbol] | [symbol] | [symbol] | [symbol] | [symbol] | [symbol] |
| [symbol] by [symbol] E | [symbol] | [symbol] | [symbol] | [symbol] | [symbol] | [symbol] | [symbol] | [symbol] | [symbol] | [symbol] | [symbol] | [symbol] | [symbol] |
| Collagen | | | | | | | | | | | | | |
| masking | | | | | | | | | | | | | |
| (reduction of | | | | | | | | | | | | | |
| strange [symbol] ) | | | | | | | | | | | | | |
| Average [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] by [symbol] A | [symbol] | [symbol] | [symbol] | [symbol] | [symbol] | [symbol] | [symbol] | [symbol] | [symbol] | [symbol] | [symbol] | [symbol] | [symbol] |
| [symbol] by [symbol] B | [symbol] | [symbol] | [symbol] | [symbol] | [symbol] | [symbol] | [symbol] | [symbol] | [symbol] | [symbol] | [symbol] | [symbol] | [symbol] |
| [symbol] by [symbol] C | [symbol] | [symbol] | [symbol] | [symbol] | [symbol] | [symbol] | [symbol] | [symbol] | [symbol] | [symbol] | [symbol] | [symbol] | [symbol] |
| [symbol] by [symbol] D | [symbol] | [symbol] | [symbol] | [symbol] | [symbol] | [symbol] | [symbol] | [symbol] | [symbol] | [symbol] | [symbol] | [symbol] | [symbol] |
| [symbol] by [symbol] E | [symbol] | [symbol] | [symbol] | [symbol] | [symbol] | [symbol] | [symbol] | [symbol] | [symbol] | [symbol] | [symbol] | [symbol] | [symbol] |
| Overall | | | | | | | | | | | | | |
| favorability | | | | | | | | | | | | | |
| Average [symbol] | [symbol] | [symbol] | [symbol] | [symbol] | [symbol] | [symbol] | [symbol] | [symbol] | [symbol] | [symbol] | [symbol] | [symbol] | [symbol] |
| [symbol] by [symbol] A | [symbol] | [symbol] | [symbol] | [symbol] | [symbol] | [symbol] | [symbol] | [symbol] | [symbol] | [symbol] | [symbol] | [symbol] | [symbol] |
| [symbol] by [symbol] B | [symbol] | [symbol] | [symbol] | [symbol] | [symbol] | [symbol] | [symbol] | [symbol] | [symbol] | [symbol] | [symbol] | [symbol] | [symbol] |
| [symbol] by [symbol] C | [symbol] | [symbol] | [symbol] | [symbol] | [symbol] | [symbol] | [symbol] | [symbol] | [symbol] | [symbol] | [symbol] | [symbol] | [symbol] |
| [symbol] by [symbol] D | [symbol] | [symbol] | [symbol] | [symbol] | [symbol] | [symbol] | [symbol] | [symbol] | [symbol] | [symbol] | [symbol] | [symbol] | [symbol] |
| [symbol] by [symbol] E | [symbol] | [symbol] | [symbol] | [symbol] | [symbol] | [symbol] | [symbol] | [symbol] | [symbol] | [symbol] | [symbol] | [symbol] | [symbol] |
| Total | [symbol] | [symbol] | [symbol] | [symbol] | [symbol] | [symbol] | [symbol] | [symbol] | [symbol] | [symbol] | [symbol] | [symbol] | [symbol] |

[symbol]

indicates data missing or illegible when filed

In addition, comparative examples were subjected to free evaluation by evaluators.

The result of the free evaluation showed that Comparative Examples 1 and 2 had a strong sweetness and lacked a balance of sweetness.

In addition, Comparative Example 3 was evaluated as having a strong bitterness.

In addition, Comparative Example 4 was evaluated as having a slight bitterness and a poor texture as a beverage.

### (3) Results and Discussion

As shown in Table 1, a beverage which contains 5 mass % or more of collagen, and contains 0.0003 mass % to 0.15 mass % of a stevia extract and 0.1 mass % to 16 mass % of sugar (sucrose) in a content mass ratio of from 1:40,000 to 1:0.6 was found to more reliably reduce the collagen-specific taste, even if its collagen content was high.

In addition, when a beverage contains 5 mass % or more of collagen, and contains 0.0003 mass % to 0.15 mass % of a stevia extract and 0.1 mass % to 16 mass % of sugar (sucrose) in a content mass ratio of from 1:40,000 to 1:0.6, the provided beverage was found to have both an improved collagen-specific taste and a balanced sweetness, even if its collagen content is high.

It was also found that the above form can provide a highly palatable beverage.

### Test Example 2

In Test Example 2, the influence of the collagen concentration on beverages was examined.

### (1) Production of Beverage

Test beverages for examples and comparative examples were produced by mixing 5 mass % of fruit juice in terms of straight juice, 0.5 mass % of flavoring, ingredients shown in Table 2, and water.

### (2) Evaluation Test

The produced beverages for examples and comparative examples were subjected to sensory evaluation based on the same criteria as in Test Example 1 by five evaluators (evaluators A to E in the table) who are experts in research and development of beverages.

The results are shown in Table 2.

TABLE 2

| | Comparative | | | |
|---|---|---|---|---|
| | Example 5 | Example 9 | Example 10 | Example 11 |
| Raw material (numerical units of ingredients, mass %) | | | | |
| Collagen | 3 | 5 | 8 | 20 |
| Sugar (sucrose) | 1.875 | 3.125 | 5 | 12.5 |
| Stevia extract (Rebaudio AD (sweetness: 310-390-fold, | 0.005625 | 0.009375 | 0.015 | 0.0375 |
| Morita Kagaku Kogyo Co., Ltd.) | | | | |
| Malic acid | 0.13 | 0.22 | 0.34 | 0.9 |
| Physical properties, etc. | | | | |
| pH | 4.49 | 4.48 | 4.47 | 4.46 |
| Brix value (Bx.) | 6.03 | 9.82 | 15.33 | 29.94 |
| Viscosity (cP) | 3.4 | 3.8 | 4.4 | 9.1 |
| Stevia extract content mass/sugar content mass | 0.003 | 0.003 | 0.003 | 0.003 |
| Sugar content mass/collagen content mass | 0.625 | 0.625 | 0.625 | 0.625 |
| Stevia extract content mass/collagen content mass | 0.001875 | 0.001875 | 0.001875 | 0.001875 |
| Sensory evaluation | X | ◯ | ◯ | ◯ |
| [Specific Evaluation] | | | | |
| Sweetness intensity | | | | |
| Average evaluation | 1.2 | 2.5 | 3 | 3.9 |
| Average score | −1.8 | −0.5 | 0 | −0.9 |
| Evaluation by evaluator A | 1 | 3 | 3 | 3.5 |
| Evaluation by evaluator B | 2 | 3 | 3 | 4 |
| Evaluation by evaluator C | 1 | 2.5 | 3.5 | 3 |
| Evaluation by evaluator D | 1 | 2 | 2.5 | 5 |
| Evaluation by evaluator E | 1 | 2 | 3 | 4 |
| Cohesion of flavor | | | | |
| Average evaluation | 1.8 | 3.6 | 4.6 | 4.4 |
| Evaluation by evaluator A | 1 | 3.5 | 4.5 | 4 |
| Evaluation by evaluator B | 2 | 4 | 5 | 4 |
| Evaluation by evaluator C | 2 | 3 | 4.5 | 5 |
| Evaluation by evaluator D | 3 | 4 | 5 | 5 |
| Evaluation by evaluator E | 1 | 3.5 | 4 | 4 |
| Collagen masking (reduction of strange taste) | | | | |
| Average evaluation | 3.3 | 4.4 | 4.7 | 4.1 |
| Evaluation by evaluator A | 3 | 5 | 4.5 | 4 |
| Evaluation by evaluator B | 4 | 4 | 5 | 3 |
| Evaluation by evaluator C | 2 | 4 | 4.5 | 5 |
| Evaluation by evaluator D | 5 | 5 | 4.5 | 4.5 |
| Evaluation by evaluator E | 2.5 | 4 | 5 | 4 |
| Overall favorability | | | | |
| Average evaluation | 1.9 | 3.9 | 4.7 | 3.8 |
| Evaluation by evaluator A | 1 | 4 | 5 | 4 |
| Evaluation by evaluator B | 2 | 4 | 4.5 | 3 |
| Evaluation by evaluator C | 2 | 3.5 | 4.5 | 4 |
| Evaluation by evaluator D | 3 | 4 | 4.5 | 4 |
| Evaluation by evaluator E | 1.5 | 4 | 5 | 4 |
| Total | 5.2 | 11.4 | 14 | 11.4 |

### (3) Results and Discussion

As shown in Table 2, when a beverage contains 0.0003 mass % to 0.15 mass % of a stevia extract and 0.1 mass % to 16 mass % of sugar (sucrose) in a content mass ratio of from 1:40,000 to 1:0.6, the provided beverage was found to have both an improved collagen-specific taste and a balanced sweetness, even if its collagen content was 5 mass % or more.

It was also found that the above form can provide a highly palatable beverage.

In addition, the test results in Table 2 show that in the form containing 0.0003 mass % to 0.15 mass % of the stevia extract and 0.1% mass % to 16 mass % of sugar (sucrose), the collagen content must be 5 mass % or more to obtain a beverage having both an improved collagen-specific taste and a balanced sweetness.

### Test Example 3

In Test Example 3, the influence of the combination of sugar (sucrose) and stevia extract on beverages was examined.

### (1) Production of Beverage

Test beverages for examples and comparative example were produced by mixing 5 mass % of fruit juice in terms of straight juice, 0.5 mass % of flavoring, ingredients shown in Table 3, and water.

### (2) Evaluation Test

The produced beverages for examples and comparative examples were subjected to sensory evaluation based on the same criteria as in Test Example 1 by five evaluators (evaluators A to E in the table) who are experts in research and development of beverages.

The results are shown in Table 3.

TABLE 3

| | Comparative | Comparative | Comparative | |
|---|---|---|---|---|
| | Example 6 | Example 7 | Example 8 | Example 12 |
| Raw material | | | | |
| Collagen | 3 | 3 | 8 | 8 |
| Sugar (sucrose) | | 5 | | 5 |
| Isomerized sugar | 5 | | 5 | |
| Stevia extract (Rebaudio AD (sweetness: 310- | 0.003 | 0.003 | 0.015 | 0.015 |
| 390-fold, Morita Kagaku Kogyo Co., Ltd.) | | | | |
| Malic acid | 0.11 | 0.31 | 0.43 | 0.34 |
| Physical properties, etc. | | | | |
| pH | 4.53 | 4.55 | 4.51 | 4.47 |
| Brix value (Bx.) | 7.98 | 9.23 | 14.04 | 15.33 |
| Viscosity (cP) | 3.7 | 3.4 | 4.2 | 4.4 |
| Stevia extract content mass/sugar content mass | 0.0006 | 0.0006 | 0.003 | 0.003 |
| Sugar content mass/collagen content mass | 1.667 | 1.667 | 0.625 | 0.625 |
| Stevia extract content mass/collagen content | 0.001 | 0.001 | 0.001875 | 0.001875 |
| mass | | | | |
| Sensory evaluation | X | X | X | ◯ |
| [Specific Evaluation] | | | | |
| Sweetness intensity | | | | |
| Average evaluation | 1.4 | 2.6 | 2.5 | 3 |
| Average score | −1.6 | −0.4 | −0.5 | 0 |
| Evaluation by evaluator A | 1 | 3 | 2 | 3 |
| Evaluation by evaluator B | 2 | 3 | 3 | 3 |
| Evaluation by evaluator C | 1.5 | 2.5 | 2.5 | 3.5 |
| Evaluation by evaluator D | 1 | 2 | 2.5 | 2.5 |
| Evaluation by evaluator E | 1.5 | 2,5 | 2.5 | 3 |
| Cohesion of flavor | | | | |
| Average evaluation | 1.6 | 2.6 | 2.6 | 4.6 |
| Evaluation by evaluator A | 1 | 3 | 2 | 4.5 |
| Evaluation by evaluator B | 2 | 3 | 2 | 5 |
| Evaluation by evaluator C | 2 | 2 | 4 | 4.5 |
| Evaluation by evaluator D | 2 | 3 | 3.5 | 5 |
| Evaluation by evaluator E | 1 | 2 | 1.5 | 4 |
| Collagen masking (reduction of strange taste) | | | | |
| Average evaluation | 3.9 | 4.2 | 3.4 | 4.7 |
| Evaluation by evaluator A | 3 | 3.5 | 3 | 4.5 |
| Evaluation by evaluator B | 4 | 4 | 3 | 5 |
| Evaluation by evaluator C | 5 | 5 | 4 | 4.5 |
| Evaluation by evaluator D | 5 | 5 | 5 | 4.5 |
| Evaluation by evaluator E | 2.5 | 3.5 | 2 | 5 |
| Overall favorability | | | | |
| Average evaluation | 2 | 3 | 2.9 | 4.7 |
| Evaluation by evaluator A | 1 | 3 | 2.5 | 5 |
| Evaluation by evaluator B | 2 | 3 | 2 | 4.5 |
| Evaluation by evaluator C | 3 | 3 | 4 | 4.5 |
| Evaluation by evaluator D | 2 | 3 | 4 | 4.5 |
| Evaluation by evaluator E | 2 | 3 | 2 | 5 |
| Total | 5.9 | 9.4 | 8.4 | 14 |

### (3) Results and Discussion

As shown in Table 3, it has been found that a combination of sugar (sucrose) and a stevia extract can provide a beverage having both an improved collagen-specific taste and a balanced sweetness.

It was also found that the above form can provide a highly palatable beverage.

### Test Example 4

In Test Example 4, the influence of addition of fruit juice on beverages was examined.

### (1) Production of Beverage

In Example 13, a test beverage was produced by mixing 5 mass % of peach juice in terms of straight juice, 0.5 mass % of peach flavoring, ingredients shown in Table 4, and water.

In Example 14, a test beverage was produced by mixing 5 mass % of lemon juice in terms of straight juice, 0.3 mass % of lemon flavoring, ingredients shown in Table 4, and water.

### (2) Evaluation Test

The produced beverages for examples and comparative examples were subjected to sensory evaluation based on the same criteria as in Test Example 1 by five evaluators (evaluators A to E in the table) who are experts in research and development of beverages.

The results are shown in Table 4.

TABLE 4

| | Exam- | Exam- |
|---|---|---|
| | ple 13 | ple 14 |
| Raw material | | |
| Collagen (collagen peptide) | 8 | 8 |
| Sugar (sucrose) | 5 | 5 |
| Stevia extract (Rebaudio AD (sweetness: | 0.015 | 0.015 |
| 310-390-fold, Morita Kagaku Kogyo Co., Ltd.) | | |
| Malic acid | 0.34 | |
| Citric acid | | 0.466 |
| Physical properties, etc. | | |
| pH | 4.47 | 4.05 |
| Brix value (Bx.) | 15.33 | 15.68 |
| Viscosity (cP) | 4.4 | 4.5 |
| Stevia extract content mass/sugar content mass | 0.003 | 0.003 |
| Sugar content mass/collagen content mass | 0.625 | 0.625 |
| Stevia extract content mass/collagen | 0.001875 | 0.001875 |
| content mass | | |
| Sensory evaluation | ◯ | ◯ |
| [Specific evaluation] | | |
| Sweetness Intensity | | |
| Average evaluation | 3 | 2.9 |
| Average score | 0 | −0.1 |
| Evaluation by evaluator A | 3 | 2.5 |
| Evaluation by evaluator B | 3 | 3 |
| Evaluation by evaluator C | 3.5 | 3 |
| Evaluation by evaluator D | 2.5 | 3 |
| Evaluation by evaluator E | 3 | 3 |
| Cohesion of flavor | | |
| Average evaluation | 4.6 | 4.6 |
| Evaluation by evaluator A | 4.5 | 4.5 |
| Evaluation by evaluator B | 5 | 4 |
| Evaluation by evaluator C | 4.5 | 4.5 |
| Evaluation by evaluator D | 5 | 5 |
| Evaluation by evaluator E | 4 | 5 |
| Collagen masking (reduction of strange taste) | | |
| Average evaluation | 4.7 | 4.6 |
| Evaluation by evaluator A | 4.5 | 4.5 |
| Evaluation by evaluator B | 5 | 4.5 |
| Evaluation by evaluator C | 4.5 | 5 |
| Evaluation by evaluator D | 4.5 | 4.5 |
| Evaluation by evaluator E | 5 | 4.5 |
| Overall favorability | | |
| Average evaluation | 4.7 | 4.8 |
| Evaluation by evaluator A | 5 | 4.5 |
| Evaluation by evaluator B | 4.5 | 4.5 |
| Evaluation by evaluator C | 4.5 | 5 |
| Evaluation by evaluator D | 4.5 | 5 |
| Evaluation by evaluator E | 5 | 5 |
| Total | 14 | 13.9 |

### (3) Results and Discussion

As shown in Table 4, when a beverage contains 5 mass % or more of collagen and contains 0.0003 mass % to 0.15 mass of a stevia extract and 0.1 mass % to 16 mass of sugar (sucrose) in a content mass ratio of from 1:40,000 to 1:0.6, the provided beverage was found to have both an improved collagen-specific taste and a balanced sweetness, even if it contains juice.

It was also found that the above form can provide a highly palatable beverage.

### Test Example 5

In Test Example 5, the influence of the type of stevia extract on beverages was examined.

### (1) Production of Beverage

Test beverages for examples and comparative example were produced by mixing 5 mass % of fruit juice in terms of straight juice, 0.5 mass % of flavoring, ingredients shown in Table 5, and water.

Here, Rebaudio AD is mainly composed of rebaudioside A.

Steviron S 100 is mainly composed of stevioside.

### (2) Evaluation Test

The produced beverages for examples and comparative examples were subjected to sensory evaluation based on the same criteria as in Test Example 1 by five evaluators (evaluators A to E in the table) who are experts in research and development of beverages.

The results are shown in Table 5.

TABLE 5

| | Exam- | Exam- |
|---|---|---|
| | ple 15 | ple 16 |
| Raw material | | |
| Collagen (collagen peptide) | 8 | 8 |
| Sugar (sucrose) | 5 | 5 |
| Stevia extract (Rebaudio AD (sweetness: 310- | 0.015 | |
| 390-fold, Morita Kagaku Kogyo Co., Ltd.) | | |
| Stevia extract (Steviron S 100 (sweetness: | | 0.015 |
| 300-fold, Morita Kagaku Kogyo Co., Ltd.) | | |
| Malic acid | 0.35 | 0.34 |
| Physical properties, etc. | | |
| pH | 4.42 | 4.45 |
| Brix value (Bx.) | 15.37 | 15.38 |
| Viscosity (cP) | 4.6 | 4.8 |
| Stevia extract content mass/sugar content mass | 0.003 | 0.003 |
| Sugar content mass/collagen content mass | 0.625 | 0.625 |
| Stevia extract content mass/collagen | 0.001875 | 0.001875 |
| content mass | | |
| Sensory evaluation | ◯ | ◯ |
| [Specific evaluation] | | |
| Sweetness intensity | | |
| Average evaluation | 3 | 3 |
| Average score | 0 | 0 |
| Evaluation by evaluator A | 3 | 3 |
| Evaluation by evaluator B | 3 | 3 |
| Evaluation by evaluator C | 3.5 | 3 |
| Evaluation by evaluator D | 2.5 | 3 |
| Evaluation by evaluator E | 3 | 3 |
| Cohesion of flavor | | |
| Average evaluation | 4.6 | 4.3 |
| Evaluation by evaluator A | 4.5 | 4.5 |
| Evaluation by evaluator B | 5 | 4.5 |
| Evaluation by evaluator C | 4.5 | 4 |
| Evaluation by evaluator D | 5 | 4.5 |
| Evaluation by evaluator E | 4 | 4 |
| Collagen masking (reduction of strange taste) | | |
| Average evaluation | 4.7 | 4.9 |
| Evaluation by evaluator A | 4.5 | 5 |
| Evaluation by evaluator B | 5 | 5 |
| Evaluation by evaluator C | 4.5 | 5 |
| Evaluation by evaluator D | 4.5 | 5 |
| Evaluation by evaluator E | 5 | 4.5 |
| Overall favorability | | |
| Average evaluation | 4.7 | 4.2 |
| Evaluation by evaluator A | 5 | 4.5 |
| Evaluation by evaluator B | 4.5 | 4 |
| Evaluation by evaluator C | 4.5 | 4 |
| Evaluation by evaluator D | 4.5 | 5 |
| Evaluation by evaluator E | 5 | 3.5 |
| Total | 14 | 13.4 |

### (3) Results and Discussion

As shown in Table 5, when a beverage contains 5 mass % or more of collagen and contains 0.0003 mass % to 0.15 mass % of rebaudioside A and/or stevioside and 0.1 mass % to 16 mass % of sugar (sucrose) in a content mass ratio of from 1:40,000 to 1:0.6, the provided beverage has both an improved collagen-specific taste and a balanced sweetness, even if its collagen content is high.

It was also found that the above form can provide a highly palatable beverage.

### Test Example 6

In Test Example 6, the influence of the origin of collagen on beverages was examined.

### (1) Production of Beverage

Test beverages for examples and comparative example were produced by mixing 5 mass % of fruit juice in terms of straight juice, 0.5 mass % of flavoring, ingredients shown in Table 6, and water.

Here, PRA (manufactured by Nippi, Inc.) was used as bovine-derived collagen.

Here, FCP-EX (manufactured by Nippi, Inc.) was used as fish-derived collagen.

### (2) Evaluation Test

The produced beverages for examples and comparative examples were subjected to sensory evaluation based on the same criteria as in Test Example 1 by five evaluators (evaluators A to E in the table) who are experts in research and development of beverages.

The results are shown in Table 6.

TABLE 6

| | Example 17 | Example 18 | Example 19 |
|---|---|---|---|
| Raw material | Pig-derived collagen | Fish-derived collagen | Bovine-derived collagen |
| Collagen (collagen peptide) | 8 | 8 | 8 |
| Sugar (sucrose) | 5 | 5 | 5 |
| Stevia extract (Rebaudio AD (sweetness: 310- | 0.015 | 0.015 | 0.015 |
| 390-fold, Morita Kagaku Kogyo Co., Ltd.) | | | |
| Malic acid | 0.34 | 0.39 | 0.5 |
| Physical properties, etc. | | | |
| pH | 4.47 | 4.4 | 4.38 |
| Brix value (Bx.) | 15.33 | 15.28 | 15.21 |
| Viscosity (cP) | 4.4 | 4.6 | 4.6 |
| Stevia extract content mass/sugar content mass | 0.003 | 0.003 | 0.003 |
| Sugar content mass/collagen content mass | 0.625 | 0.625 | 0.625 |
| Stevia extract content mass/collagen content mass | 0.001875 | 0.001875 | 0.001875 |
| Sensory evaluation | ◯ | ◯ | ◯ |
| [Specific evaluation] | | | |
| Sweetness intensity | | | |
| Average evaluation | 3 | 3.2 | 3.2 |
| Average score | 0 | −0.2 | −0.2 |
| Evaluation by evaluator A | 3 | 3 | 3 |
| Evaluation by evaluator B | 3 | 3 | 3 |
| Evaluation by evaluator C | 3.5 | 4 | 4 |
| Evaluation by evaluator D | 2.5 | 3 | 3 |
| Evaluation by evaluator E | 3 | 3 | 3 |
| Cohesion of flavor | | | |
| Average evaluation | 4.6 | 4.6 | 4.6 |
| Evaluation by evaluator A | 4.5 | 4 | 4.5 |
| Evaluation by evaluator B | 5 | 5 | 5 |
| Evaluation by evaluator C | 4.5 | 5 | 5 |
| Evaluation by evaluator D | 5 | 5 | 4.5 |
| Evaluation by evaluator E | 4 | 4 | 4 |
| Collagen masking (reduction of strange taste) | | | |
| Average evaluation | 4.7 | 3.8 | 3.9 |
| Evaluation by evaluator A | 4.5 | 4 | 5 |
| Evaluation by evaluator B | 5 | 4.5 | 4 |
| Evaluation by evaluator C | 4.5 | 3.5 | 3 |
| Evaluation by evaluator D | 4.5 | 4 | 4.5 |
| Evaluation by evaluator E | 5 | 3 | 3 |
| Overall favorability | | | |
| Average evaluation | 4.7 | 3.6 | 3.8 |
| Evaluation by evaluator A | 5 | 3.5 | 4.5 |
| Evaluation by evaluator B | 4.5 | 4 | 4 |
| Evaluation by evaluator C | 4.5 | 3.5 | 3 |
| Evaluation by evaluator D | 4.5 | 3.5 | 4 |
| Evaluation by evaluator E | 5 | 3.5 | 3.5 |
| Total | 14 | 11.8 | 12.1 |

### (3) Results and Discussion

As shown in Table 6, when a beverage contains 5 mass % or more of collagen and contains 0.0003 mass % to 0.15 mass % of a stevia extract and 0.1 mass % to 16 mass % of sugar (sucrose) in a content mass ratio of from 1:40,000 to 1:0.6, the provided beverage was found to have both an improved collagen-specific taste and a balanced sweetness, whether the collagen is derived from pigs, cows, or fish.

It was also found that the above form can provide a highly palatable beverage.

### Test Example 7

In Test Example 7, the influence of the Rakanka extract on beverages was examined.

### (1) Production of Beverage

Test beverages for examples and comparative examples were produced by mixing 5 mass % of fruit juice in terms of straight juice, 0.5 mass % of flavoring, ingredients shown in Table 7, and water.

### (2) Evaluation Test

The produced beverages for examples and comparative examples were subjected to sensory evaluation based on the same criteria as in Test Example 1 by five evaluators (evaluators A to E in the table) who are experts in research and development of beverages.

The results are shown in Table 7.

TABLE 7

| | Example 20 | Example 21 |
|---|---|---|
| Raw material | Stevia | Stevia |
| | extract | extract + |
| | | Rakanka |
| | | extract |
| Collagen (collagen peptide) | 8 | 8 |
| Sugar (sucrose) | 5 | 5 |
| Stevia extract (Rebaudio AD (sweetness: | 0.015 | 0.0135 |
| 310-390-fold, Morita Kagaku Kogyo Co., | | |
| Ltd.) | | |
| Rakanka extract (MV-50, Saraya Co., Ltd.) | | 0.0015 |
| Malic acid | 0.34 | 0.39 |
| Physical properties, etc. | | |
| pH | 4.47 | 4.4 |
| Brix value (Bx.) | 15.33 | 16.28 |
| Viscosity (cP) | 4.4 | 4.6 |
| Stevia extract content mass/sugar content | 0.003 | 0.0027 |
| mass | | |
| Sugar content mass/collagen content | 0.625 | 0.625 |
| mass | | |
| Stevia extract content mass/collagen | 0.001875 | 0.0016875 |
| content mass | | |
| Sensory evaluation | ◯ | ◯ |
| [Specific evaluation] | | |
| Sweetness intensity | | |
| Average evaluation | 3 | 3 |
| Average score | 0 | 0 |
| Evaluation by evaluator A | 3 | 3 |
| Evaluation by evaluator B | 3 | 3 |
| Evaluation by evaluator C | 3.5 | 3.5 |
| Evaluation by evaluator D | 2.5 | 2.5 |
| Evaluation by evaluator E | 3 | 3 |
| Cohesion of flavor | | |
| Average evaluation | 4.6 | 4.7 |
| Evaluation by evaluator A | 4.5 | 4.5 |
| Evaluation by evaluator B | 5 | 5 |
| Evaluation by evaluator C | 4.5 | 4.5 |
| Evaluation by evaluator D | 5 | 5 |
| Evaluation by evaluator E | 4 | 4.5 |
| Collagen masking (reduction of strange taste) | | |
| Average evaluation | 4.7 | 4.9 |
| Evaluation by evaluator A | 4.5 | 5 |
| Evaluation by evaluator B | 5 | 5 |
| Evaluation by evaluator C | 4.5 | 5 |
| Evaluation by evaluator D | 4.5 | 4.5 |
| Evaluation by evaluator E | 5 | 5 |
| Overall favorability | | |
| Average evaluation | 4.7 | 4.8 |
| Evaluation by evaluator A | 5 | 5 |
| Evaluation by evaluator B | 4.5 | 4.5 |
| Evaluation by evaluator C | 4.5 | 5 |
| Evaluation by evaluator D | 4.5 | 4.5 |
| Evaluation by evaluator E | 5 | 5 |
| Total | 14 | 14.4 |

### (3) Results and Discussion

As shown in Table 7, when a beverage contains 5 mass % or more of collagen,
contains 0.0003 mass % to 0.15 mass of a stevia extract and 0.1 mass % to 16 mass % of sugar (sucrose) in a content mass ratio of from 1:40,000 to 1:0.6, and further contains a Rakanka extract, the provided beverage was found to have both an improved collagen-specific taste and a balanced sweetness, even if its collagen content is high.

It was also found that the above form can provide a highly palatable beverage.

### Test Example 8

In Test Example 8, the influence of the molecular weight of collagen on beverages was examined.

### (1) Production of Beverage

Test beverages for examples and comparative examples were produced by mixing 5 mass % of fruit juice in terms of straight juice, 0.5 mass % of flavoring, ingredients shown in Table 8, and water.

### (2) Evaluation Test

The produced beverages for examples and comparative examples were subjected to sensory evaluation based on the same criteria as in Test Example 1 by five evaluators (evaluators A to E in the table) who are experts in research and development of beverages.

The results are shown in Table 8.

TABLE 8

| | Example 22 | Example 23 | Example 24 | Example 25 |
|---|---|---|---|---|
| Raw material | Collagen molecular | Collagen molecular | Collagen molecular | Collagen molecular |
| | weight: 1,000 | weight: 2,000 | weight: 5,000 | weight: 10,000 |
| Collagen (collagen peptide) | 8 | 8 | 8 | 8 |
| Sugar (sucrose) | | 5 | 5 | 5 |
| Stevia extract (Rebaudio AD | 0.015 | 0.015 | 0.015 | 0.015 |
| (sweetness: 310-390-fold, Morita | | | | |
| Kagaku Kogyo Co., Ltd.) | | | | |
| Malic acid | 0.35 | 0.34 | 0.35 | 0.28 |
| Physical properties, etc. | | | | |
| pH | 4.51 | 4.47 | 4.44 | 4.48 |
| Brix value (Bx.) | 15.37 | 15.33 | 15.04 | 15.25 |
| Viscosity (cP) | 4.1 | 4.4 | 5.0 | 6.6 |
| Stevia extract content | 0.003 | 0.003 | 0,003 | 0.003 |
| mass/sugar content mass | | | | |
| Sugar content mass/collagen | 0.625 | 0.626 | 0.625 | 0.625 |
| content mass | | | | |
| Stevia extract content | 0.001875 | 0.001875 | 0.001875 | 0.001875 |
| mass/collagen content mass | | | | |
| Sensory evaluation | ◯ | ◯ | ◯ | ◯ |
| [Specific evaluation] | | | | |
| Sweetness Intensity | | | | |
| Average evaluation | 2.5 | 3 | 3.2 | 3.5 |
| Average score | −0.5 | 0 | −0.2 | −0.5 |
| Evaluation by evaluator A | 2.5 | 3 | 3 | 3.5 |
| Evaluation by evaluator B | 3 | 3 | 3 | 3.5 |
| Evaluation by evaluator C | 2 | 3.5 | 3 | 4 |
| Evaluation by evaluator D | 3 | 2.5 | 4 | 2.5 |
| Evaluation by evaluator E | 2 | 3 | 3 | 4 |
| Cohesion of flavor | | | | |
| Average evaluation | 4.1 | 4.6 | 4.4 | 4.2 |
| Evaluation by evaluator A | 4 | 4.5 | 4 | 4 |
| Evaluation by evaluator B | 4.5 | 5 | 5 | 4.5 |
| Evaluation by evaluator C | 5 | 4.5 | 4 | 4 |
| Evaluation by evaluator D | 4 | 5 | 5 | 4.5 |
| Evaluation by evaluator E | 3 | 4 | 4 | 4 |
| Collagen masking (reduction | | | | |
| of strange taste) | | | | |
| Average evaluation | 4.1 | 4.7 | 4.5 | 4.7 |
| Evaluation by evaluator A | 4 | 4.5 | 4 | 5 |
| Evaluation by evaluator B | 4.5 | 5 | 4.5 | 5 |
| Evaluation by evaluator C | 5 | 4.5 | 4 | 5 |
| Evaluation by evaluator D | 4 | 4.5 | 5 | 4.5 |
| Evaluation by evaluator E | 3 | 5 | 5 | 4 |
| Overall favorability | | | | |
| Average evaluation | 4.5 | 4.7 | 4.3 | 4.3 |
| Evaluation by evaluator A | 4.5 | 5 | 4 | 4.5 |
| Evaluation by evaluator B | 5 | 4.5 | 4.5 | 4.5 |
| Evaluation by evaluator C | 5 | 4.5 | 4 | 4 |
| Evaluation by evaluator D | 4 | 4.5 | 5 | 4.5 |
| Evaluation by evaluator E | 4 | 5 | 4 | 4 |
| Total | 12.2 | 14 | 13 | 12.7 |

### (3) Results and Discussion

As shown in Table 8, when a beverage contains 5 mass % or more of collagen and contains 0.0003 mass % to 0.15 mass % of a stevia extract and 0.1 mass % to 16 mass % of sugar (sucrose) in a content mass ratio of from 1:40,000 to 1:0.6, the provided beverage was found to have both an improved collagen-specific taste and a balanced sweetness, without particular limitation on the molecular weight of collagen.

It was also found that the above form can provide a highly palatable beverage.

### Test Example 9

In Test Example 9, the influence of the pH of the collagen-containing beverage on beverages was examined.

### (1) Production of Beverage

Test beverages for examples and comparative example were produced by mixing 5 mass % of fruit juice in terms of straight juice, 0.5 mass % of flavoring, ingredients shown in Table 9, and water.

### (2) Evaluation Test

The produced beverages for examples and comparative examples were subjected to sensory evaluation based on the same criteria as in Test Example 1 by five evaluators (evaluators A to E in the table) who are experts in research and development of beverages.

The results are shown in Table 9.

TABLE 9

| | Example 26 | Example 27 | Example 28 |
|---|---|---|---|
| Raw material | | | |
| Collagen (collagen peptide) | 8 | 8 | 8 |
| Sugar (sucrose) | 5 | 5 | 5 |
| Stevia extract (Rebaudio AD (sweetness: 310- | 0.015 | 0.015 | 0.015 |
| 390-fold, Morita Kagaku Kogyo Co., Ltd.) | | | |
| Malic acid | 0.74 | 0.34 | 0.23 |
| Physical properties, etc. | | | |
| pH | 3.8 | 4.47 | 4.68 |
| Brix value (Bx.) | 15.51 | 15.33 | 15.08 |
| Viscosity (cP) | 4.6 | 4.4 | 4.3 |
| Stevia extract content mass/sugar content | 0.003 | 0.003 | 0.0 |
| mass | | | |
| Sugar content mass/collagen content mass | 0.825 | 0.625 | 0.6 |
| Stevia extract content mass/collagen content | 0.001875 | 0.001875 | 0.0 |
| mass | | | |
| Sensory evaluation | ◯ | ◯ | ◯ |
| [Specific evaluation] | | | |
| Sweetness intensity | | | |
| Average evaluation | 1.4 | 3 | 3.4 |
| Average score | −1.6 | 0 | −0.4 |
| Evaluation by evaluator A | 1.5 | 3 | 4. |
| Evaluation by evaluator B | 1 | 3 | 3 |
| Evaluation by evaluator C | 2 | 3.5 | 3 |
| Evaluation by evaluator D | 1 | 2.5 | 3 |
| Evaluation by evaluator E | 1.5 | 3 | 4 |
| Cohesion of flavor | | | |
| Average evaluation | 3.7 | 4.6 | 4.4 |
| Evaluation by evaluator A | 4 | 4.5 | 5 |
| Evaluation by evaluator B | 4 | 5 | 4 |
| Evaluation by evaluator C | 4.5 | 4.5 | 4 |
| Evaluation by evaluator D | 3 | 5 | 5 |
| Evaluation by evaluator E | 3 | 4 | 4 |
| Collagen masking (reduction of | | | |
| strange taste) | | | |
| Average evaluation | 4 | 4.7 | 4.5 |
| Evaluation by evaluator A | 4.5 | 4.5 | 4 |
| Evaluation by evaluator B | 4 | 5 | 4.5 |
| Evaluation by evaluator C | 3 | 4.5 | 4 |
| Evaluation by evaluator D | 4.5 | 4.5 | 5 |
| Evaluation by evaluator E | 4 | 5 | 5 |
| Overall favorability | | | |
| Average evaluation | 4.4 | 4.7 | 4.3 |
| Evaluation by evaluator A | 4.5 | 5 | 4 |
| Evaluation by evaluator B | 5 | 4.5 | 4.5 |
| Evaluation by evaluator C | 4.5 | 4.5 | 5 |
| Evaluation by evaluator D | 4 | 4.5 | 4 |
| Evaluation by evaluator E | 4 | 5 | 4 |
| Total | 10.5 | 14 | 12.8 |

### (3) Results and Discussion

As shown in Table 9, when a beverage contains 5 mass % or more of collagen and contains 0.0003 mass % to 0.15 mass % of a stevia extract and 0.1 mass % to 16 mass % of sugar (sucrose) in a content mass ratio of from 1:40,000 to 1:0.6, the provided beverage was found to have both an improved collagen-specific taste and a balanced sweetness, without particular limitation on the pH of the beverage.

It was also found that the above form can provide a highly palatable beverage.

### INDUSTRIAL APPLICABILITY

The present invention can be used for the production of beverages.

1. A beverage comprising 5 mass % or more of collagen,
which comprises 0.0003 mass % to 0.15 mass % of a stevia extract and 0.1 mass % to 16 mass % of sugar (sucrose) in a content mass ratio of from 1:40,000 to 1:0.6.

2. The beverage according to claim 1, wherein the stevia extract comprises rebaudioside A and/or stevioside.

3. The beverage according to claim 1, wherein the collagen content in the beverage is 40 mass % or less.

4. The beverage according to claim 1, further comprising a Rakanka extract.

5. The beverage according to claim 4, wherein the content mass ratio of the stevia extract to the Rakanka extract is from 1:0.05 to 1:0.2.

6. A method for producing a collagen-rich beverage having an improved taste, comprising a step of adjusting 5 mass % or more of collagen, 0.0003 mass % to 0.15 mass % of a stevia extract, and 0.1 mass % to 16 mass % of sugar (sucrose) so that the content mass ratio of the stevia extract to sugar (sucrose) is from 1:40,000 to 1:0.6.

7. The beverage according to claim 2, wherein the collagen content in the beverage is 40 mass % or less.

8. The beverage according to claim 2 further comprising a Rakanka extract.

9. The beverage according to claim 3 further comprising a Rakanka extract.

10. The beverage according to claim 7 further comprising a Rakanka extract.

11. The beverage according to claim 8, wherein the content mass ratio of the stevia extract to the Rakanka extract is from 1:0.05 to 1:0.2.

12. The beverage according to claim 9, wherein the content mass ratio of the stevia extract to the Rakanka extract is from 1:0.05 to 1:0.2.

13. The beverage according to claim 10, wherein the content mass ratio of the stevia extract to the Rakanka extract is from 1:0.05 to 1:0.2.
